(19) United States
(12) Patent Application Publication
(10) Pub. No.: US 2006/0051645 A1
(43) Pub. Date: Mar. 9, 2006

(54) Fuel cell stack with high output current and low output voltage

(76) Inventors: Liqing Hu, Shanghai (CN); Yong Zhou, Shanghai (CN)

Correspondence Address: RAYMOND Y. CHAN, 108 N. YNEZ AVE., SUITE 128, MONTEREY PARK, CA, 91754, US

(21) Appl. No.: 10/935,773

(22) Filed: Sep. 7, 2004

(51) Int. Cl. H01M 8/10; H01M 8/24

(52) U.S. Cl. 429/32; 429/34; 429/38

(57) ABSTRACT

A fuel cell stack includes a plurality of anode bus plates and a plurality of cathode bus plates disposed between two end plates of a fuel cell stack in such a manner that at least two cell units as a cell set are grouped between the anode bus plate and the cathode bus plate, wherein each of the anode bus plates is positioned at an anode end of the respective cell set and each of the cathode bus plates is positioned at a cathode end of the respective cell set, wherein when the anode and cathode bus plates are electrically connected in a parallel manner, the anode and cathode bus plates accumulatively collect an electrical energy of the cell set therebetween so as to substantially enhance an output current of the fuel cell stack with minimized output voltage.

### BACKGROUND OF THE PRESENT INVENTION

1. Field of Invention

The present invention relates to fuel cell system, and more particularly to a fuel cell stack with higher output current and relatively lower output voltage.

2. Description of Related Arts

Electrochemical fuel cell is a kind of electrochemical energy conversion device which is capable of converting the hydrogen and oxidant into electrical energy. The core element of such device is the Membrane Electrode Assembly (MEA). The MEA comprises a proton exchange membrane sandwiched by two porous sheets of conductive material such as carbon tissue. At the same time, two layers of catalyst like metal platinum powder, adapted for facilitating the electrochemical reaction, are evenly and granularly loaded on two layers of carbon tissue respectively to form two catalytic interfaces. Furthermore, electric-conductive members are provided on both sides of the MEA to form electrodes of anode and cathode respectively in such a manner that electrons generated during the electrochemical reaction are leaded from the electrodes to construct an electric circuit.

At the anode of the MEA, the fuel such as hydrogen which permeates through the carbon tissue initiates an electrochemical reaction on the catalytic interface that fuel molecules lose electrons to form positive ions. The positive ions are transferred to penetrate through the proton exchange membrane to the cathode. At the cathode of the MEA, an oxidant-containing gas such as air which permeates through the carbon tissue initiates an electrochemical reaction that gas molecules gain electrons to form negative ions. The negative ions formed at the cathode react with the positive ions transferred from the anode to form a reactive product.

In the fuel cell which employs the hydrogen as the fuel and oxygen containing air (or pure oxygen) as the oxidant, the catalytic electrochemical reaction at the anode generates hydrogen positive ions (protons). The proton exchange membrane is capable of facilitating the hydrogen positive ions to migrate from the anode to the cathode. In addition, the proton exchange member also functions as a separator for blocking hydrogen containing air flow from being directly contacted with the oxygen containing air flow so as to prevent the hydrogen and the oxygen from mixing with each other to avoid explosive reaction.

At the cathode, oxygen molecules gain electrons on the catalytic interface to form the negative ions which react with the positive ions transferred from the anode to water molecule as the reaction product. In the electrochemical fuel cells which utilize the hydrogen as the fuel and oxygen containing air as oxidant, the anode reaction and cathode reaction are expressed by the following formulas:
Anode: H₂→2H⁺+2e
Cathode: 1/2O₂+2H⁺+2e→H₂O

In the typical proton exchanging membrane fuel cell system, the MEA is disposed between two electrode plates wherein the contacting interface of each electrode plate at least defines one flowing channel which can be made by conventional mechanical method such as pressure casting, punching, and mechanical milling. The electrode plate can be a metal electrode plate or graphite electrode plate. So the flowing channels defined on the electrode plates are capable of directing fuel and oxidant into the anode manifoldion and the cathode manifoldion of the MEA respectively.

Generally, for each cell unit of the proton exchanging membrane fuel cell stack, only one MEA is provided and disposed between an anode plate for fuel and a cathode plate for oxidant. In which, the anode plate and the cathode plate are not only embodied as electrical current electrode plate, but also embodied as a mechanical supmanifolding device for securely holding the MEA at its two sides. The flowing channels defined on the electrode plates function as channels to deliver the fuel and the oxidant to the anode and cathode interfaces and to remove the water discharged during the electrochemical reaction of fuel cell.

In order to increase the overall power output of the proton exchanging membrane fuel cell, two or more cell units are electrically connected in series in a stacked manner or a successive manner to form a fuel cell stack. In such stacked series manner, each electrode plate comprises flowing channels defined on opposite sides of the electrode plate respectively, wherein one side of the electrode plate is applied as an anode plate contacting with the anode interface of a MEA while another side of the electrode plate is applied as a cathode plate contacting with the cathode interface of an adjacent MEA. In other words, one side of such electrode plate serve as an anode plate for one cell unit and the other side of the electrode plate serve as a cathode plate for the adjacent cell unit, i.e. so called bipolar plate. However, in the successive series manner, a plurality of fuel cells is connected successively, wherein a front end plate, a rear end plate and a compression means are provided to form a fuel cell stack.

Conclusively, a typical fuel cell, as shown in FIG. 2, comprises a manifold arrangement 13A at the electrode plate 12A to communicate with the MEA 11A of the cell unit. The manifold arrangement 13A comprises first, second and third manifolds individually formed on the electrode plate 12A. Accordingly, the first manifold has a first inlet and a first outlet adapted for evenly dispersing fuel, such as hydrogen, methanol, alcohol, natural gas, and hydrogen rich gas reformed from gasoline into the anode flowing channel. The second manifold has a second inlet and a second outlet adapted for evenly dispersing oxidant, such as oxygen and air, into the cathode flowing channel. The third manifold has a third inlet and a third outlet adapted for delivering coolant such as water into coolant manifold provided in the fuel cell stack and absorbing the heat generated during the electrochemical reaction inside the fuel cell stack for a radiation purpose. The first and second outlets are also adapted for discharging the water generated during the electrochemical reaction. Commonly, all above mentioned inlets and outlets are defined on the electrode plate 12A or two opposite end plates.

In addition, the cell units of the fuel cell stack are connected in a series manner that the anode end of each cell unit is facing towards the cathode end of the adjacent cell unit. Therefore, the output voltage of the fuel cell stack is the sum of voltage of the cell units output from the two electrode plate 12A. It is worth to mention that manifold arrangement 13A for the structural configuration of such fuel cell stack is that the flows of the fuel, oxidant and coolant are at the same direction to evenly pass through the cell units when the cell units are stacked to form the first, second and third manifolds. Since the manifold arrangement 13A also collects both the reactant and non-reactant of the fluids (fuel, oxidant and coolant) when the fluids pass through the cell units, the first, second and third manifolds having the same size and shape must be constructed in a particular location that they are not interchangeable.

Conventionally, the fuel cell stacks can be generally used as power systems for propelling vehicles including four-wheeled motor vehicles and motorcycles and operating as power generators.

It is noted that the current output of a proton exchange membrane fuel cell is primarily determined by the working area of electrodes of the fuel cell. For instance, when the fuel cell is operated under 0.5 ampere/(every square centimeter of MEA) electrical current density, the fuel cell having a 200 square centimeter of MEA is capable of outputting a 100 ampere current. On the other hand, the current output of a proton exchange membrane fuel cell is highly correlated with the quantity of the fuel cells for building up a fuel cell stack. To increase the overall power output of the proton exchanging membrane fuel cell, a plurality of fuel cells, each outputting a 0.5 to 1 voltage, is electrically connected in series to form a fuel cell stack.

Since the proton exchange membrane fuel cells are required to be applicable under various power range, different factors such as effective area of the MEA, size and shape of electrode plates, quantity of the fuel cell, and etc. must be considered and evaluated for the engineering design of the fuel cell stack.

As a result, the height and width, as well as the output current of a fuel cell stack are determined by the size of the effective area of the electrode plate and the MEA. Also, the length and output voltage of the fuel cell stack are determined by the number of cell units in the fuel cell stack.

Accordingly, one of the popular types of fuel cell stacks (Mark-9 type single module fuel cell stack, developed by the Ballard Power System Corporation) utilizes the above mentioned engineering concepts to build a fuel cell stack in bigger size of width and height (about 120 centimeters) for power system or electric generator that requires larger output power. On the other hand, for lower power manifoldable electric generator, another type fuel cell stack having a relatively smaller width and height (less than 5 centimeter) is utilized. However, in order to increase output power, the number of cell units as well as its length have to be increased to as long as several tens of centimeters.

In short, the above mentioned engineering design principle is to guarantee that the fuel cell stack is capable of outputting adaptive current and voltage under different circumstances. Nevertheless, the fuel cell stacks designed according to the above engineering design principles suffer the following insurmountable drawbacks while applying in a larger current and lower voltage application.

1. According to the above mentioned engineering design principles, when the fuel cell stack is required to provide a large output current, the working area of each electrode plate will be increased. However, in some special applications, like electrolysis and galvanization industry, a larger electrical current is required to reach an extent like more than 1000 amperes, even a couple of thousands of amperes. Unfortunately, it is impossible to unlimitedly increase the working area of electrode plate to satisfy such a huge output current.

2. According to the above mentioned engineering design principles, when the fuel cell stack is required to provide a lower voltage output, the number of the cell units of a fuel cell stack will be reduced. However, in some special applications, like electrolysis and galvanization industry, an extreme lower electrical voltage is required to reach an extent from 2 to 5 voltages, but such small number of cell units also greatly limits the possible output power of the fuel cell stack.

3. If a conventional fuel cell stack is applied, the output voltage must be higher than 5 voltages, and the output current must be less than 1000 ampere. To solve this dilemma, the extra rectification devices have to be used to provide lower voltage and higher current. Unfortunately, the rectification efficiency is only around 80% to 90% which would waste considerable electrical energy.

As shown in FIG. 1, the fuel cell stack is divided into several sub-fuel cell stacks 10B, wherein each of the sub-fuel cell stacks 10B is provided between two bus plates 11B on either ends of such sub-fuel cell stacks 10B, namely an anode bus plate and a cathode bus plate.

However, even such improved fuel cell stack, developed by Shanghai Shenli Technology Ltd., is capable of providing a multiple increased current and a multiple decreased voltages, it still has room for improvement. In fact, each of sub-fuel cell stacks 10B must be separated with an extra insulating plate 12B and the bus plates 11B respectively for anode current collection and cathode current collection. As a result, the parallel connection of the anode and cathode bus plates 11B as well as the insulating plate 12B substantially need considerable connecting materials that results in a longer bulky fuel cell stack.

### SUMMARY OF THE PRESENT INVENTION

A main object of the present invention is to provide a fuel cell stack that can produce a higher output current and a relatively lower output voltage while having a common size thereof.

Another object of the present invention is to provide a fuel cell stack, which anode and cathode bus plates are electrically connected in a parallel manner to increase the output current thereof in a multiple manner.

Another object of the present invention is to provide a fuel cell stack, which anode and cathode bus plates are intervally disposed between two end plates to accumulatively collect an electrical energy of the cell set therebetween.

Another object of the present invention is to provide a fuel cell stack which is able to overcome that above mentioned drawbacks and facilitates the fuel cell stack to output a multiple increased current while maintaining a normal size and even the shape.

Accordingly, to achieve the above mention objects the present invention provides a fuel cell stack, comprising:
a plurality of cell sets each having one or more cell units electrically connected with each other and having an anode end and a cathode end, wherein each of the cell units comprises a MEA having a plurality of pores, and two electrode plates attached to two opposed sides of the MEA for electrochemical reaction;
two end plates provided at two ends of the fuel cell stack respectively to retain the cell units in position; and
a plurality of common anode and cathode bus plates disposed between the two end plates in such a manner that each of the cell sets is sandwiched between one of the common anode bus plates and one of the common cathode bus plates, wherein each of the common anode bus plates is positioned at the anode end of the respective cell set and each of the common cathode bus plates is positioned at the cathode end of the respective cell set, wherein when the common anode and cathode bus plates are electrically connected in a parallel manner, the common anode and cathode bus plates accumulatively collect an electrical energy of the cell set therebetween and each of the common anode and cathode bus plates also functioned as the anode bus plate or cathode bus plate of another adjacent cell set, thereby the fuel cell stack is capable of producing a higher output current with a relatively lower output voltage.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a conventional fuel cell stack.

FIG. 2 is a partial schematic view of the conventional fuel cell stack illustrating cell units connected in series within a fuel cell stack.

FIG. 3 is a partial schematic view of a fuel cell stack according to the first preferred embodiment of the present invention illustrating the cell units disposed within a sub-fuel cell stack.

FIG. 4 is a schematic view of the fuel cell stack according to the first preferred embodiment of the present invention.

FIG. 5 is a sectional view of the MEA according to the first preferred embodiment of the present invention.

FIG. 6 is a sectional view of an electrode plate according to the first preferred embodiment of the present invention.

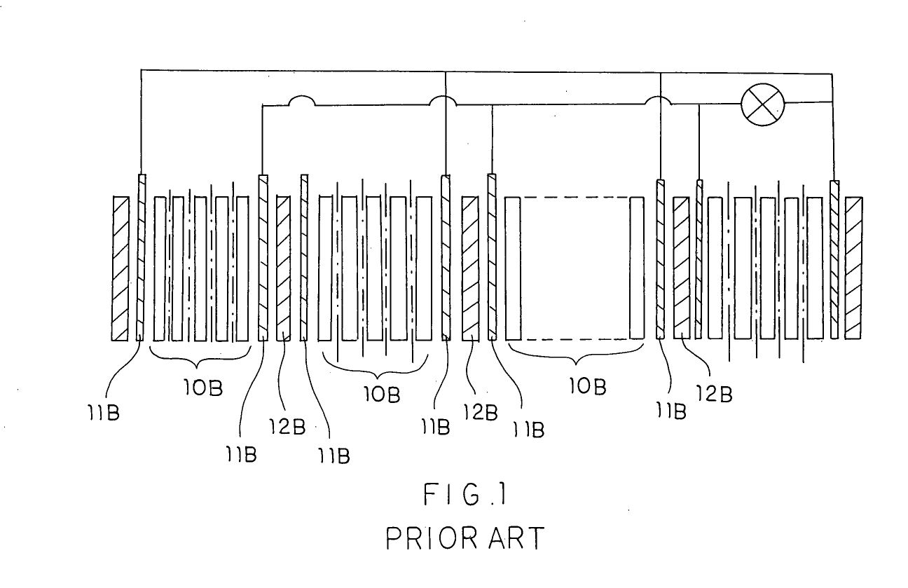

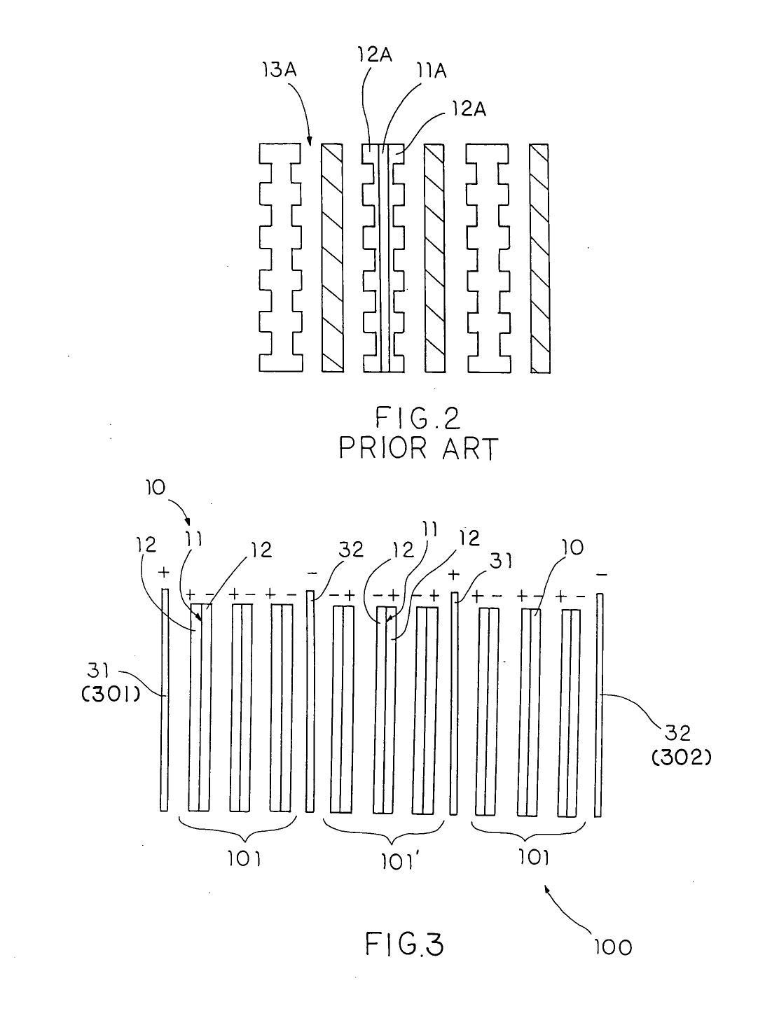

### DETAILED DESCRIPTION OF THE PREFERRED EMBODIMENT

Referring to FIGS. 3 to 6 of the drawings, a fuel cell stack according to a preferred embodiment of the present invention is illustrated, wherein the fuel cell comprises a plurality of cell units 10 electrically connected with each other to form a fuel cell stack 100, and two end plates 20 provided at two ends of the fuel cell stack 100 respectively to retain the cell units 10 in position.

The cell units 10 are grouped into a plurality of cell sets 101 each having an anode end and a cathode end. Each of the cell units 10 comprises a MEA 11 having a plurality of pores and two electrode plates 12 attached to two opposed sides of the MEA 11 for electrochemical reaction.

The fuel cell stack 100 further comprises a plurality of common anode and cathode bus plates 31, 32 disposed between the two end plates 20 in such a manner that at least one cell set 101 is sandwiched between one of the common anode bus plates 31 and one of the common cathode bus plates 32. Each of the common anode bus plates 31 is positioned at the anode end of the respective cell set 101 and each of the common cathode bus plates 32 is positioned at the cathode end of the respective cell set 101, wherein each of the common anode and cathode bus plates 31, 32 also functioned as the anode bus plate 31 or cathode bus plate 32 of another adjacent cell set 101.

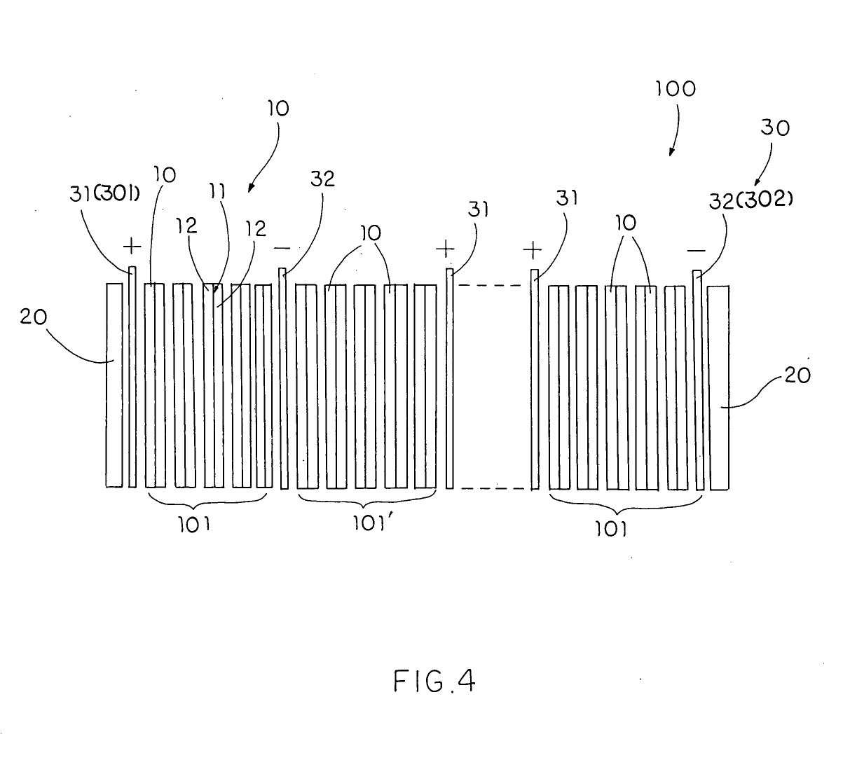

According to the preferred embodiment as shown in FIGS. 3 and 4 of the present invention, one of the common anode bus plates 31 is positioned at the leftmost position as an anode bus end plate 301 and one of the common cathode bus plates 32 is positioned at the rightmost position as a cathode bus end plate 302. Three cell units 10 are paraellelly sandwiched in series to form a first cell set 101 having the anode end at the left side and the cathode end at the right side, as shown in FIG. 3. One of the common cathode bus plates 32 is positioned at the left side of the first cell set 101 to sandwich the first cell set 101 therebetween. The anode end of the first cell set 101 is positioned at the common anode bus plate 31 and the cathode end of the first cell set 101 is positioned at the common cathode bus plate 32 which also functions as the cathode bus plate of a second cell set 101′ adjacent to the first cell set 101, wherein the adjacent cell set 101′ has its cathode end at its left side and its anode end at its right side. Another common anode bus plate 31 is positioned at the right side, i.e. the anode end, of such adjacent cell set 101′ and functions as the common anode bus plate 31 of a third cell set 101 positioned adjacent to the right side of the second cell set 101′, wherein the third cell unit 101 is sandwiched between the common second anode bus plate 31 and a common second cathode bus plate 32, as shown in FIG. 3.

Accordingly, when a pair of the common anode and cathode bus plates 31, 32 are electrically connected in a parallel manner, the common anode and cathode bus plates 31, 32 accumulatively collect an electrical energy of the cell set 101 or 101′ therebetween so as to enable the fuel cell stack 100 to produce a higher output current and a relatively lower output voltage.

According to the preferred embodiment, the conventional MEA 11 (Membrane Electrode Assembly) can be used that comprises a proton exchange membrane, such as carbon tissue, having the pores formed thereon and load with catalyst. At least an elongated insulate bolts can be used to penetrate through the two end plates 20 to firmly attach the two end plates 20 in position such that the cell units 10, the common anode bus plates 31 and the common cathode bus plates 32 are securely sandwiched between the two end plates 20.

The fuel cell stack further comprises means 50 for supplying fuel, oxidant and coolant to the cell units 10 to electrochemically react with the MEA 11. Accordingly, the fuel and the oxidant are separately guided to flow to the cell units 10 wherein the fuel, such as hydrogen, is guided to flow to the cell units 10 to supply electrons to the MEAs 11 and the oxidant is adapted for attracting electrons through the proton exchange membrane of each of the MEAs 11 to complete the electrochemical reaction of the cell units 10.

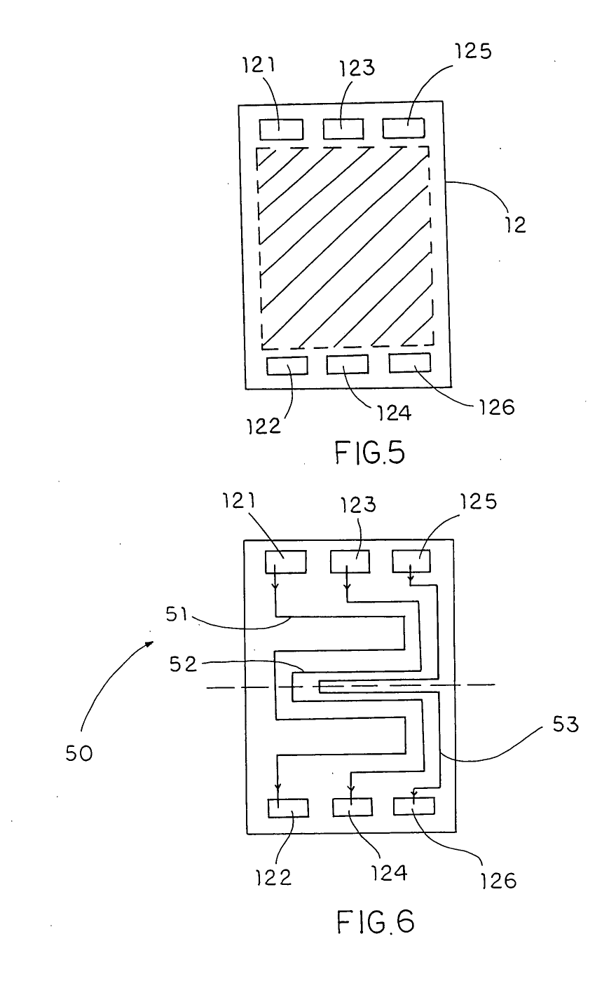

As shown in FIGS. 5 and 6, one of the electrode plates 12 in each of the cell units 10 has a fuel inlet manifold 121 for guiding the fuel entering into the cell unit 10, a corresponding fuel outlet manifold 122 for discharging the fuel, an oxidant inlet manifold 123 for guiding the oxidant entering into the cell unit 10, a corresponding oxidant outlet manifold 124 for discharging the oxidant, a coolant inlet manifold 125 for guiding the coolant entering into the cell unit 10, a corresponding coolant outlet manifold 126 for discharging the coolant.

According to the preferred embodiment, the supplying means 50 comprises a fuel manifold 51 communicatively extended from the fuel inlet manifold 121 to the fuel outlet manifold 122 to guide the flow of the fuel from the fuel inlet manifold 121 to the fuel outlet manifold 122, an oxidant manifold 52 communicatively extended from the oxidant inlet manifold 123 to the oxidant outlet manifold 124 to guide the flow of the oxidant from the oxidant inlet manifold 123 to the oxidant outlet manifold 124, and a coolant manifold 53 communicatively extended from the coolant inlet manifold 125 to the coolant outlet manifold 126 to guide the flow of the coolant from the coolant inlet manifold 125 to the coolant outlet manifold 126.

As shown in FIG. 6, the fuel inlet manifold 121, the oxidant inlet manifold 123 and the coolant inlet manifold 125 are symmetrically positioned to the fuel outlet manifold 122, the oxidant outlet manifold 124 and the coolant outlet manifold 126 respectively, such that when the anode end of the cell unit 10 is switched with the cathode end thereof in an interchanging bipolar manner, the electrode plate 12 is adapted to be 180-degree flipped over to swap between the fuel inlet manifold 121 and the fuel outlet manifold 122, to swap between the oxidant inlet manifold 123 and the oxidant outlet manifold 124, and to swap between the coolant inlet manifold 125 and the coolant outlet manifold 126.

In other words, even the cell units 10 are switched in oppositely orientation, the fuel manifold 51 is still aligned with the fuel inlet manifold 121 and the fuel outlet manifold 122, the oxidant manifold 52 is still aligned with the oxidant inlet manifold 123 and the oxidant outlet manifold 124, and the coolant manifold 53 is still aligned with the coolant inlet manifold 125 and the coolant outlet manifold 126 so as to prevent any disorderly flow and delivery of fuel, oxidant and coolant to the cell unit 10. Therefore, no alternation of the supply means 50 is required for the opposite orientations of the cell units 10. Thus, the supplying means 50 can also collects both the reactant and non-reactant of the fluids (fuel, oxidant and coolant) through the fuel manifold 51, the oxidant manifold 52 and the coolant manifold 53 when the fluids pass therethrough when the electrode plate 12 is 180-degree flipped.

As shown in FIG. 3, the cell units 10 in each of the cell sets 101, 101′ are connected in series. In other words, the cell units 10 in each of the cell sets 101, 101′ are orderly orientated that the anode end of the cell unit 10 is electrically connected with the cathode end of the neighboring cell unit 10 in each cell set 101. It is worth to mention that the cell set 101 can include only one cell unit 10 as a single unit set. However, two or more cell units 10 are preferably connected with each other to form the cell set 101. In other words, the anode end of the cell set 101 is the anode end of the cell unit 10 at the first location of the cell set 101 while the cathode end of the cell set 101 is the cathode end of the cell unit 10 at the last location of the cell set 101.

The common anode bus plates 31 and the common cathode bus plates 32 are intervally disposed between the two end plates 20 to form the cell sets 101 therebetween, wherein, except the leftmost common anode bus plate 31 (the anode bus end plate 301) and the rightmost common cathode bus plate 32 (the cathode bus end plate 302), adjacent to the two end plates 20, every common cathode bus plate 32 is positioned between two common anode bus plates 32 and every anode bus plate is positioned between two common cathode bus plates 31. In other words, at least one of the common anode bus plates 31 is formed as an anode sharing bus plate positioned between two neighboring cell sets 101 to communicate the two anode ends of said two neighboring cell sets 101, and at least one of the common cathode bus plates 32 is formed as a cathode sharing bus plate positioned between two neighboring cell sets 101 to communicate two cathode ends of the two neighboring cell sets 101, as shown in FIG. 3. In other words, the common anode bus plate 31 is sandwiched between two anode ends of two neighboring cell sets 101, 101′ and the common cathode bus plate 32 is sandwiched between two cathode ends of two neighboring cell sets 101, 101′.

It is appreciated that, according to the present invention, in each cell set 101 or 101′, the anode and cathode terminals of each cell unit 10 are aligned in the same direction, however the anode and cathode terminals of each cell unit 10 of an adjacent cell set 101 or 101′ thereof are aligned in the opposite direction, so that the anode and cathode ends of each of the cell sets 101, 101′ should be in opposite direction of the anode and cathode ends of adjacent cell set 101, 101′. Therefore, according to the present invention, two cell sets 101, 101′ having opposite positions of the anode and cathode ends share an electrode bus plate 31, 32, either a common anode bus plate 31 or a common cathode bus plate 32. The common anode bus plate 31 should face the anode end of the cell set 101, 101′ and the common cathode bus plate 32 should face the cathode end of the cell set 101, 101′.

In addition, due to the configuration between the common anode and cathode bus plates 31, 32, the cell sets 101′ are positioned in an opposite orientation manner that the anode end of the cell set 101 is facing towards the anode end of the neighboring cell set 101 and the cathode end of the cell set 101′ is facing towards the cathode end of the neighboring cell set 101.

According to the preferred embodiment, the common anode and cathode bus plates 31, 32 are electrically connected in a parallel manner that the electrical energy of each of the cell sets 101 is accumulatively collected to substantially increase an output current of the fuel cell stack 100 without increasing the output voltage.

It is worth to mention that the output current of the fuel cell stack 100 can be increased in a multiple manner by the number of cell units 10 while the output voltage of the fuel cell stack 100 can be remained the same as the output voltage of each of the cell units 10. For example, the effective area of the MEA 11 is 280 cm³. The height of each of the electrode plates 12 is 200 mm, the width of each of the electrode plates 12 is 206 mm, and the thickness of each of the electrode plates 12 is 5 cm. The working pressure of the fuel and oxidant is approximately from 0.5 to 2 atm and the temperature thereof is 76° C. When the output voltage of each of the cell units 10 is 0.6V, the voltage density of the MEA 11 is 0.8 A/cm³. When ten cell sets 101 are used to form the fuel cell stack 100 and each of the cell sets 10 has 3V of output voltage and 224 A of output current, the overall output current of the fuel cell stack 100 can be substantially increased to 2240 A while the overall output voltage of the fuel cell stack 100 is remained at 3V as the output voltage of each single cell unit 10.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A fuel cell stack, comprising:
a plurality of cell sets each having one or more cell units electrically connected with each other and having an anode end and a cathode end, wherein each of said cell units comprises a MEA having a plurality of pores, and two electrode plates attached to two opposed sides of said MEA for electrochemical reaction;
two end plates provided at two ends of said fuel cell stack respectively to retain said cell units in position;
an anode bus end plate and a cathode bus end plate, wherein said anode and cathode bus end plates are disposed between said two end plates; and
a plurality of common anode bus plates and common cathode bus plates disposed between said anode and cathode bus end plates in such a manner that each of said cell sets is sandwiched between one of said common anode bus plates and one of said common cathode bus plates, wherein each of said common anode bus plates is positioned between two said anode ends of said two adjacent cell sets, wherein each of said common cathode bus plates is positioned between two cathode ends of said two adjacent cell sets, wherein when said common anode and cathode bus plates are electrically connected, said common anode and cathode bus plates accumulatively collect an electrical energy of said cell set therebetween.

2. The fuel cell stack, as recited in claim 1, wherein said cell units in each of said cell sets are connected in a series manner.

3. The fuel cell stack, as recited in claim 1, wherein said cell sets are positioned in an opposite orientation manner that said anode end of said cell set is facing towards said anode end of said neighboring cell set and said cathode end of said cell set is facing towards said cathode end of said neighboring cell set.

4. The fuel cell stack, as recited in claim 2, wherein said cell sets are positioned in an opposite orientation manner that said anode end of said cell set is facing towards said anode end of said neighboring cell set and said cathode end of said cell set is facing towards said cathode end of said neighboring cell set.

5. The fuel cell stack, as recited in claim 11, wherein said common anode bus plates, said common cathode bus plates, said anode bus end plates and said cathode bus end plates are electrically connected in a parallel manner.

6. The fuel cell stack, as recited in claim 2, wherein said common anode bus plates, said common cathode bus plates, said anode bus end plates and said cathode bus end plates are electrically connected in a parallel manner.

7. The fuel cell stack, as recited in claim 3, wherein said common anode bus plates, said common cathode bus plates, said anode bus end plates and said cathode bus end plates are electrically connected in a parallel manner.

8. The fuel cell stack, as recited in claim 4, wherein said common anode bus plates, said common cathode bus plates, said anode bus end plates and said cathode bus end plates are electrically connected in a parallel manner.

9. The fuel cell stack, as recited in claim 1, wherein said common anode bus plates and said common cathode bus plates are intervally disposed between said two end plates to form said cell sets therebetween.

10. The fuel cell stack, as recited in claim 2, wherein said common anode bus plates and said common cathode bus plates are intervally disposed between said two end plates to form said cell sets therebetween.

11. The fuel cell stack, as recited in claim 4, wherein said common anode bus plates and said common cathode bus plates are intervally disposed between said two end plates to form said cell sets therebetween.

12. The fuel cell stack, as recited in claim 8, wherein said common anode bus plates and said common cathode bus plates are intervally disposed between said two end plates to form said cell sets therebetween.

13. The fuel cell stack, as recited in claim 1, further comprising means for supplying fuel, oxidant and coolant to said cell units to electrochemically react with said MEA, wherein one of said electrode plates in said cell unit has a fuel inlet manifold for guiding said fuel entering into said cell unit, a corresponding fuel outlet manifold for discharging said fuel, an oxidant inlet manifold for guiding said oxidant entering into said cell unit, a corresponding oxidant outlet manifold for discharging said oxidant, a coolant inlet manifold for guiding said coolant entering into said cell unit, a corresponding coolant outlet manifold for discharging said coolant.

14. The fuel cell stack, as recited in claim 4, further comprising means for supplying fuel, oxidant and coolant to said cell units to electrochemically react with said MEA, wherein one of said electrode plates in said cell unit has a fuel inlet manifold for guiding said fuel entering into said cell unit, a corresponding fuel outlet manifold for discharging said fuel, an oxidant inlet manifold for guiding said oxidant entering into said cell unit, a corresponding oxidant outlet manifold for discharging said oxidant, a coolant inlet manifold for guiding said coolant entering into said cell unit, a corresponding coolant outlet manifold for discharging said coolant.

15. The fuel cell stack, as recited in claim 8, further comprising means for supplying fuel, oxidant and coolant to said cell units to electrochemically react with said MEA, wherein one of said electrode plates in said cell unit has a fuel inlet manifold for guiding said fuel entering into said cell unit, a corresponding fuel outlet manifold for discharging said fuel, an oxidant inlet manifold for guiding said oxidant entering into said cell unit, a corresponding oxidant outlet manifold for discharging said oxidant, a coolant inlet manifold for guiding said coolant entering into said cell unit, a corresponding coolant outlet manifold for discharging said coolant.

16. The fuel cell stack, as recited in claim 12, further comprising means for supplying fuel, oxidant and coolant to said cell units to electrochemically react with said MEA, wherein one of said electrode plates in said cell unit has a fuel inlet manifold for guiding said fuel entering into said cell unit, a corresponding fuel outlet manifold for discharging said fuel, an oxidant inlet manifold for guiding said oxidant entering into said cell unit, a corresponding oxidant outlet manifold for discharging said oxidant, a coolant inlet manifold for guiding said coolant entering into said cell unit, a corresponding coolant outlet manifold for discharging said coolant.

17. The fuel cell stack, as recited in claim 13, wherein said fuel inlet manifold, said oxidant inlet manifold and said coolant inlet manifold are symmetrically positioned to said fuel outlet manifold, said oxidant outlet manifold and said coolant outlet manifold respectively, such that when said anode end of said cell unit is switched with said cathode end thereof in an interchanging bipolar manner, said electrode plate is adapted to be 180-degree flipped over to swap between said fuel inlet manifold and said fuel outlet manifold, to swap between said oxidant inlet manifold and said oxidant outlet manifold, and to swap between said coolant inlet manifold and said coolant outlet manifold.

18. The fuel cell stack, as recited in claim 14, wherein said fuel inlet manifold, said oxidant inlet manifold and said coolant inlet manifold are symmetrically positioned to said fuel outlet manifold, said oxidant outlet manifold and said coolant outlet manifold respectively, such that when said anode end of said cell unit is switched with said cathode end thereof in an interchanging bipolar manner, said electrode plate is adapted to be 180-degree flipped over to swap between said fuel inlet manifold and said fuel outlet manifold, to swap between said oxidant inlet manifold and said oxidant outlet manifold, and to swap between said coolant inlet manifold and said coolant outlet manifold.

19. The fuel cell stack, as recited in claim 15, wherein said fuel inlet manifold, said oxidant inlet manifold and said coolant inlet manifold are symmetrically positioned to said fuel outlet manifold, said oxidant outlet manifold and said coolant outlet manifold respectively, such that when said anode end of said cell unit is switched with said cathode end thereof in an interchanging bipolar manner, said electrode plate is adapted to be 180-degree flipped over to swap between said fuel inlet manifold and said fuel outlet manifold, to swap between said oxidant inlet manifold and said oxidant outlet manifold, and to swap between said coolant inlet manifold and said coolant outlet manifold.

20. The fuel cell stack, as recited in claim 16, wherein said fuel inlet manifold, said oxidant inlet manifold and said coolant inlet manifold are symmetrically positioned to said fuel outlet manifold, said oxidant outlet manifold and said coolant outlet manifold respectively, such that when said anode end of said cell unit is switched with said cathode end thereof in an interchanging bipolar manner, said electrode plate is adapted to be 180-degree flipped over to swap between said fuel inlet manifold and said fuel outlet manifold, to swap between said oxidant inlet manifold and said oxidant outlet manifold, and to swap between said coolant inlet manifold and said coolant outlet manifold.
